(19) United States
(12) Patent Application Publication
(10) Pub. No.: US 2010/0233423 A1
(43) Pub. Date: Sep. 16, 2010

(54) MOULDING MATERIALS

(75) Inventors: Thomas Joseph Corden, Derbyshire (GB); Jonathan Philip Grigson, Tulsa, OK (US)

Correspondence Address: PEARNE & GORDON LLP, 1801 EAST 9TH STREET, SUITE 1200, CLEVELAND, OH, 44114-3108, US

(73) Assignee: Advanced Composites Group Limited, Derbyshire (GB)

(21) Appl. No.: 12/301,857

(22) PCT Filed: May 21, 2007
(86) PCT No.: PCT/GB2007/001884

§ 371 Date: Feb. 18, 2009

Related U.S. Application Data
(60) Provisional application No. 60/747,859, filed on May 22, 2006.
(60) Provisional application No. 60/871,457, filed on Dec. 22, 2006.

(51) Int. Cl. B32B 5/12; B29C 70/34; D02G 3/22; D03D 15/00; B26D 1/00

(52) U.S. Cl. 428/113; 264/258; 428/364; 428/401; 442/189; 442/304; 428/292.1; 428/375; 83/13

(57) ABSTRACT

The invention provides moulding materials methodology for manufacturing such moulding materials, articles moulded from such materials, kits and methodology for moulding articles using said materials, the moulding materials comprising a fibrous material comprising continuous reinforcement fibres at least some of which are cut at least one point along their length. Continuous reinforcement fibres are generally unidirectional fibres, woven, knitted, braided or stitched fibrous materials.

The present invention relates to moulding materials, the manufacture of moulding materials, moulded articles and moulding methods using moulding materials, and particularly but not exclusively to moulding materials and methods for the production of fibre reinforced composites.

Fibre reinforced composite materials are generally formed using, and thus comprise, fibre reinforcement materials of two main types, often referred to as discontinuous and continuous reinforcements.

Discontinuous fibre reinforcement generally comprises short lengths of fibre randomly orientated within the fibre layer. The relative short lengths of such random “mats” of fibres provide moulding materials formed therewith good drape characteristics, which enables such materials to conform to relatively intricate mould surfaces without significant problems of bridging in corners. Bridging is a term used where the moulding material does not conform accurately to the shape of the mould, particularly at corners, but in effect cuts across or bridges over the corner without assuming the definition and shape of the corner in the mould.

Disadvantages of such discontinuous fibrous reinforcements are that the random fibres do not pack well and so the fibre volume fractions of such materials are limited to approximately 30%. Such relatively low fibre volume fractions provide for relatively low performance of materials and articles produced therefrom, particularly In terms of mechanical properties.

Continuous fibre reinforcements are generally unidirectional, woven, knitted, braided or stitched fibrous materials that comprise relatively long lengths of fibres. Unidirectional fibrous materials are formed from bobbins of fibre that are arranged on a creel stand and numerous tows of fibre are run through guides to provide a flat sheet or web of fibres where the fibres all extend generally in the same direction. The fibres are generally organised in a well packed manner and thus have typically high fibre volume fractions in the order of 55-60%. This means that articles produced using unidirectional fibres tend to have relatively good mechanical properties and the surface finish tends to be superior in comparison to those of articles produced with non-unidirectional fibre reinforcements. However a distinct disadvantage of unidirectional material is its inability to move in the direction of the fibre length which means that moulding material formed using unidirectional fibre reinforcements suffers from disadvantages of bridging and lack of drape over complex geometrics. This can be a significant disadvantage when using such materials to form complex shapes which require a level of flexibility in the direction along the lengths of the fibres to eliminate bridging.

Woven, knitted, stitched and braided fibre reinforcements generally comprise relatively long lengths of fibre interwoven according to conventional techniques to form a fibre layer. Again, such fibrous layers have a generally uniform structure, but the fibres generally do not pack as efficiently as in unidirectional material. A typical woven fabric prepreg will have a fibre volume fraction of between 40 and 55%. A disadvantage of woven reinforcements is that the weaving process introduces crimp and waviness to the fibre layer. Fibres reinforce resin most efficiently when they are absolutely straight, especially with relation to the compression properties of the composite form therefrom. Fibres that are already kinked, such as in woven, knitted and braided fibres, may tend to buckle. Further, woven prepregs again suffer from problems of “bridging” when the fibres do not follow the tool or mould contours exactly, leading to components with poorly defined corners, which again can be detrimental to the mechanical performance and/or appearance of a component formed therefrom. The problems of “bridging” experienced with woven prepregs tend to be less than those associated with unidirectional prepregs, but nonetheless problems with bridging remain.

According to the present invention there is provided a moulding material comprising a fibrous material having continuous reinforcement fibres at least some of which are cut at least one point along their length.

Preferably each fibre comprises a plurality of sections at least some, but preferably all of which are generally aligned along the length of the fibre. Each section comprises a relatively short length of fibre and preferably adjacent sections of adjacent fibres extend generally parallel to each other. Preferably each relatively short length of fibre is between 5 and 100 mms in length, and preferably within the range 15 to 75 mms.

Preferably at least some of the cut fibres are cut at a plurality of points along their length. Some or all of the said plurality of cuts may be equispaced along the length of the fibre, or otherwise are preferably in predetermined locations.

Preferably the cuts within the layer are configured such that the material remains generally intact. Preferably at least some of the fibres within the materiel are unidirectional and extend generally in one direction, said fibres preferably including the or some of the cut fibres. Cuts within the material extend in a lateral direction across the direction of the length of the unidirectional fibres, preferably extending across a plurality of adjacent fibres. At least one of the cuts may extend generally perpendicularly to the direction of the unidirectional fibres. Alternatively, or in addition, the cuts may extend at an angle, preferably of between 20° and 110°. The angle may be between 20° to 60° and desirably at about 45° to the direction of the unidirectional fibres.

Preferably one or more of the cuts extends across only some of the said fibres in the material and preferably across between 5 and 50% and desirably 15 to 30% of the said fibres. The, each or some of the cuts may be substantially linear.

Alternatively, or in addition, one or more cuts may extend across all of the unidirectional fibres, preferably to extend across the width of the moulding material.

A pattern of cuts may be provided across the fibrous material, which pattern may comprise a generally regular and perhaps repeating pattern of cuts. Some cuts may be aligned, and preferably coaxial in a lateral direction across the fibres. The said some cut fibres may comprise alternative cuts across the fibres.

Cuts may be selectively provided at one or more regions of the fibrous material, which regions have been predetermined as regions where the material will be required to conform to relatively complex or intricate shapes or profiles during moulding, the cuts facilitating conformation. The configuration of the cuts is such that they act to facilitate deformation of the material and thus conformation by facilitating, for example, improved drape of the material at that/those region(s). At regions where the material will not be required to exhibit enhanced conformability, the number of cuts can be reduced or reduced to none.

Preferably the fibrous material is in the form of a sheet or layer. The cut or at least some of the cuts preferably extend through the layer or sheet.

Preferably the fibrous layer comprises a unidirectional material with a fibre volume fraction in the order of 40% to 70%, and preferably 55% to 60%.

Alternatively the fibrous layer may comprise a woven, stitched, knitted or braided fabric with a fibre volume fraction of approximately 30% to 65%, and preferably 40% to 55%.

The moulding material, may comprise support means to support the fibrous material and in particular cut fibres within the material to help retain them in said alignment and thus maintain the integrity of the material. The support means is particularly provided to retain the integrity of the fibrous material when one or more cuts extend completely or substantially completely thereacross. The support means may comprise a layer of support material on which the fibrous material is carried. The fibrous material may be attached to the support means, preferably releasably. The support means may comprise a plastics material, paper, resinous material, fibre reinforced resinous material or other suitable support material.

Alternatively, or in addition, the moulding material may comprise a resinous material, which is preferably a curable resinous material, at least partially impregnated into the fibrous material.

Alternatively, or in addition, a layer of resinous material may be provided on at least one surface of the fibrous material with preferably partial or no impregnation. The resinous material may be in the form of a prepreg, and may comprise the aforesaid support means.

The resinous material may comprise thermoset resin, such as one or more of epoxy, BMI, cyanate ester, phenolic resin.

Alternatively or in addition the resinous material may comprise thermoplastic resin, such as one or more of PES, PPIS, PI, PEI, PEEK.

Alternatively, or in addition, the moulding material may comprise a second fibrous material, which may be in the form of a sheet or layer, on one side of the said fibrous material. The said second fibrous material may comprise a continuous fibre structure, such as a unidirectional, woven, stitched, braided and/or knitted fabric or alternatively it may comprise a discontinuous fibre structure, such as isotropic chopped mat.

The moulding material may comprise a plurality of layers of fibrous material as described in any of the preceding fifteen paragraphs at least one of said layers may be orientated relative to the other, or at least one of the other layers, such that the direction of the fibres particularly for unidirectional fibres in the respective layers cross and are preferably generally mutually perpendicular.

Preferably in one embodiment, the moulding material comprises two adjacent layers of said fibrous material, orientated such that the cut or at least some of the cuts, in one layer cross over each other and preferably extend generally perpendicular to the or at least some of the cuts in the other layer. It is preferred that cuts in adjacent layers do not directly coincide or superimpose with one another as this could result in unacceptable weaknesses in articles moulded from the moulding material. Providing cuts at angles other than 90° across the general direction of the fibres can help facilitate lamination of adjacent layers, which is often done manually, by reducing the probability of superimposing cuts.

According to a second aspect of the present invention there is provided a method of manufacturing a moulding material having a fibrous material comprising continuous reinforcement fibres, the method comprising cutting at least some of said continuous reinforcement fibres at least one point along their length.

Preferably each cut fibre is cut into a plurality of sections, at least some, but preferably all of which are generally aligned. Preferably each cut fibre is cut to comprise a series of relatively short lengths of fibre and such that adjacent sections of adjacent fibres extend generally parallel to each other. Preferably the fibres are cut to a length of between 5 and 100 mms, and preferably between 15 and 75 mms. The or at least some of the cuts extend through the fibrous material.

Preferably cut fibres are cut at a plurality of points along their length. Some or all of the plurality of cuts may be equispaced along the length of the fibre, or otherwise are preferably at predetermined locations.

Preferably the cuts are made such that the material remains generally intact. Preferably at least some of the fibres within the material are unidirectional, extending generally in one direction within the material, said fibres comprising the cut fibres. Preferably the cuts within the material are made in a lateral direction across the said direction of the length of the fibres, preferably extending across a plurality of adjacent fibres.

Preferably one or more of the cuts are made to extend generally perpendicularly to the direction of the unidirectional fibres.

Alternatively, or in addition one or more of the cuts may be made at an angle, preferably of between 20° and 110°. The angle may be between 20° and 60° and desirably at about 45° to the direction of the unidirectional fibres.

Preferably one or more of the cuts are made to extend across only some of the said fibres in the material, and preferably over between 5 and 50% and desirably 15 to 30% of the said fibres.

Alternatively, or in addition, one or more of the cuts are made to extend across all of the unidirectional fibres and thus preferably to extend across the full width of the fibrous material.

A pattern of units may be made across the fibrous material, which pattern may comprise a generally regular and perhaps repeatable pattern. Some units may be aligned and preferably coaxial in a lateral direction across the fibres. The said cut fibres may comprise alternate cuts across the fibres.

The fibrous material used may be in the form of a sheet or layer. Preferably the or at least some of the cuts are made to extend through the sheet or layer.

Preferably the fibrous layer comprises a unidirectional material with a fibre volume fraction in the order of 40% to 70% and preferably 55% to 60%.

Alternatively, the fibre material used may comprise woven, stitched, knitted or braided fabric with a fibre volume fraction of approximately 30% to 65% and preferably 40% to 55%.

A support means may be used to support the fibrous material and in particular cut fibres within the material to help retain them in said alignment and thus maintain the integrity of the material. The support means used is particularly provided to maintain the integrity of the material when one or more cuts extend completely or substantially completely across the material. The support means used may comprise a layer of support material on which the fibrous material is carried. The fibrous material may be attached to the support means, preferably releasably. The support means used may comprise a plastics material, paper, resinous material or other suitable support material.

Alternatively or in addition the moulding material may comprise resinous material, which is preferably a curable resinous material. The resinous material used may be at least partially impregnated into the fibrous material.

Alternatively or in addition a layer of resinous material may be provided on at least one surface of the fibrous material with preferably partial or no impregnation. The resinous material may be in the form of a prepreg and may comprise the aforesaid support means.

The resinous material may comprise thermoset resin, such as one or more of epoxy, BMI, cyanate ester, phenolic resin.

Alternatively or in addition the resinous material may comprise thermoplastic resin, such as one or more of PES, PPIS, PI, PEI, PEEK.

Alternatively, or in addition, the moulding material may be manufactured with a second fibrous material, which may be in the form of a sheet or layer, on one side of the said fibrous material. The second fibrous material used may comprise a continuous fibre structure, such as unidirectional, woven, stitched, knitted or braided fabric or alternatively it may comprise a discontinuous fibre structure, such as isotropic chopped mat.

The moulding material may be manufactured using a plurality of layers of fibrous material as described above, in which case at least one of said layers may be orientated relative to the or at least one of the other layers such that the direction of the fibres particularly for unidirectional fibres in the respective layers are generally mutually perpendicular.

Preferably, in one embodiment, the moulding material is manufactured to comprise two layers of said fibrous materials, orientated such that the cut or at least some of the cuts across the fibres in one layer extend generally perpendicularly to the cut or at least some of the cuts in the other layer. Preferably such multilayered materials are arranged such that cuts within the adjacent layers are not superimposed, although they may cross.

According to a third aspect of the present invention there is provided a moulded article formed using a moulding material as described in any of paragraphs seven to forty one above.

According to a fourth aspect of the present invention there is provided a method of moulding an article using a moulding material as described in any of paragraphs seven to forty one above, the method comprising laying one or more layers of said moulding material in a mould or on a tool and subjecting said material to conditions to mould said material.

Said conditions may comprise conditions to cure said material, which may comprise conditions of elevated temperature and/or pressure.

According to a fifth aspect of the present invention there is provided a laminating kit comprising a plurality of moulding materials for laminating, the materials being as described in any of paragraphs seven to forty one above.

Embodiments of the present invention will now be described by way of example only, with reference to the accompanying drawings in which:—

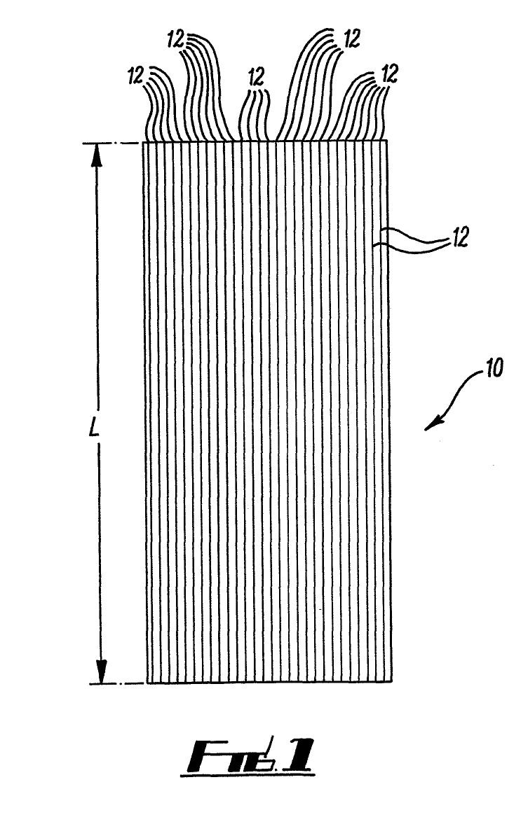

FIG. 1 is a diagrammatic view of a unidirectional fibre layer for use in certain embodiments of the present invention;

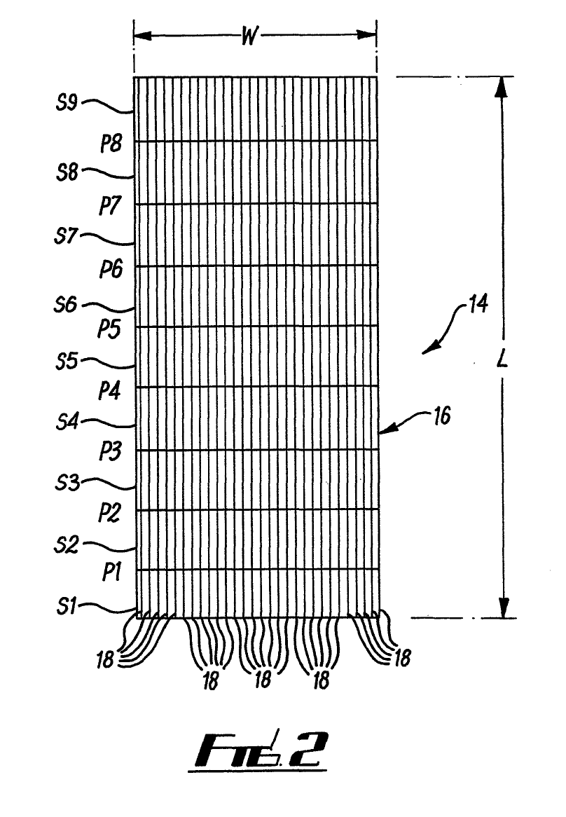

FIG. 2 is a moulding material according to a first embodiment of the present invention;

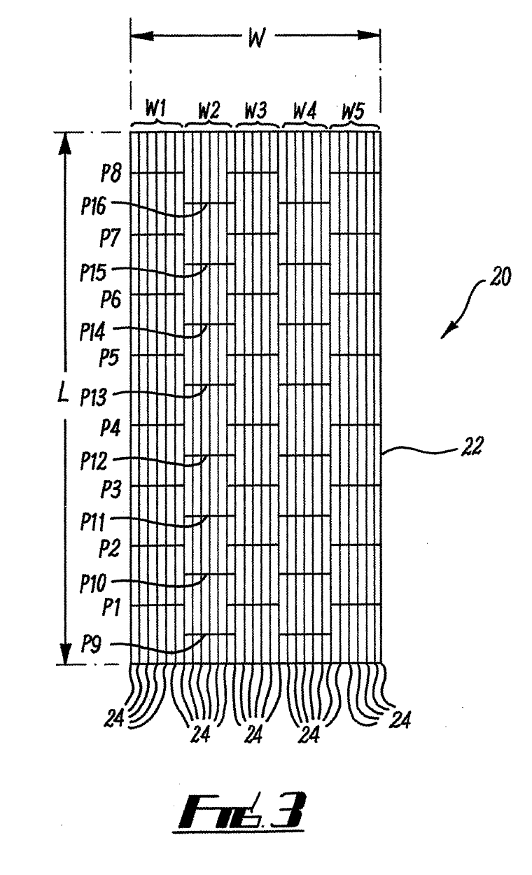

FIG. 3 is a moulding material according to a second embodiment of the present invention;

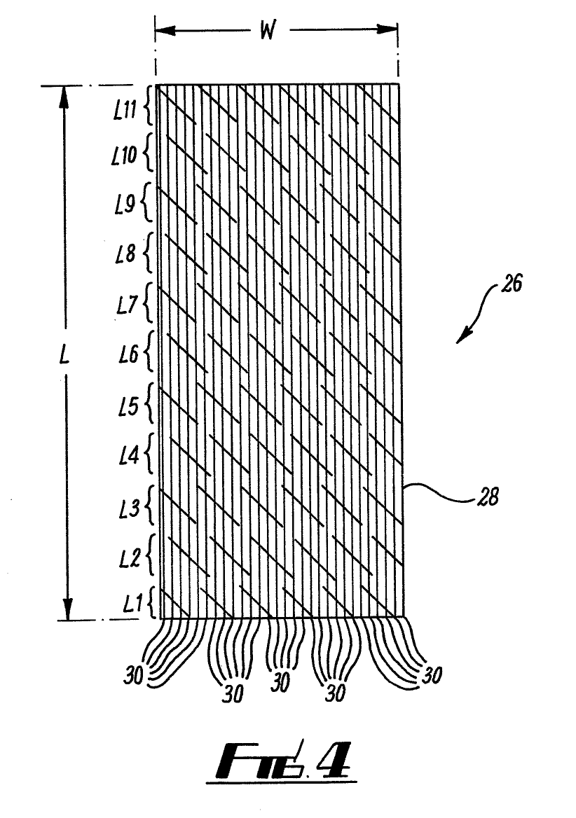

FIG. 4 is a moulding material according to a third embodiment of the present invention;

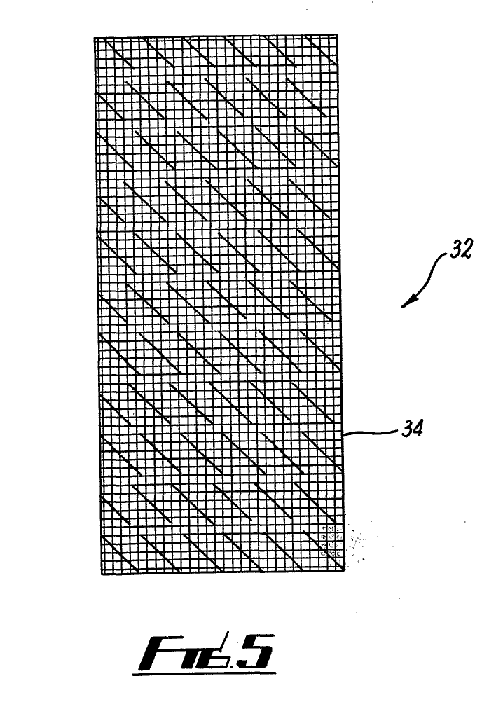

FIG. 5 is a moulding material according to a fourth embodiment of the present invention;

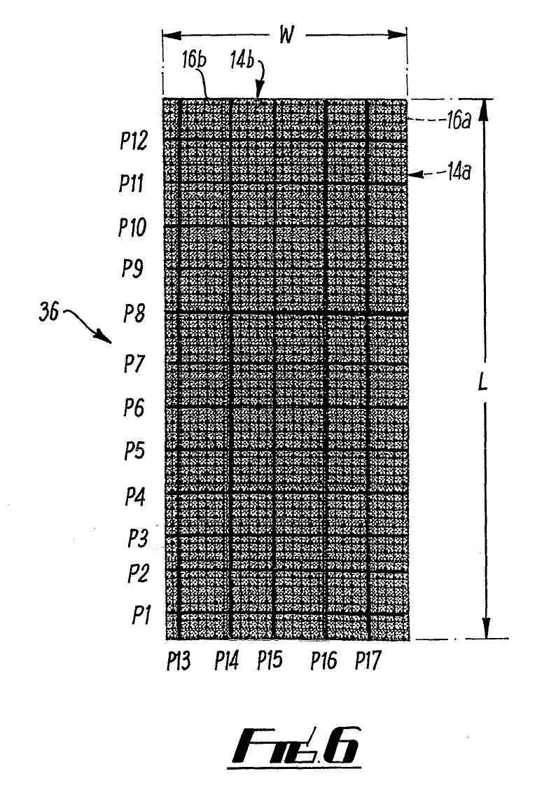

FIG. 6 is a moulding material according to a fifth embodiment of the present invention;

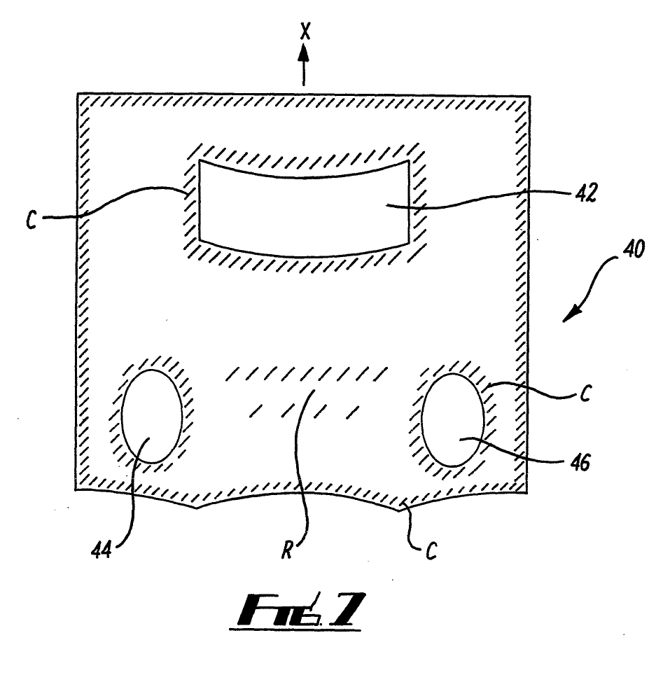

FIG. 7 is a moulding material according to a sixth embodiment of the present invention;

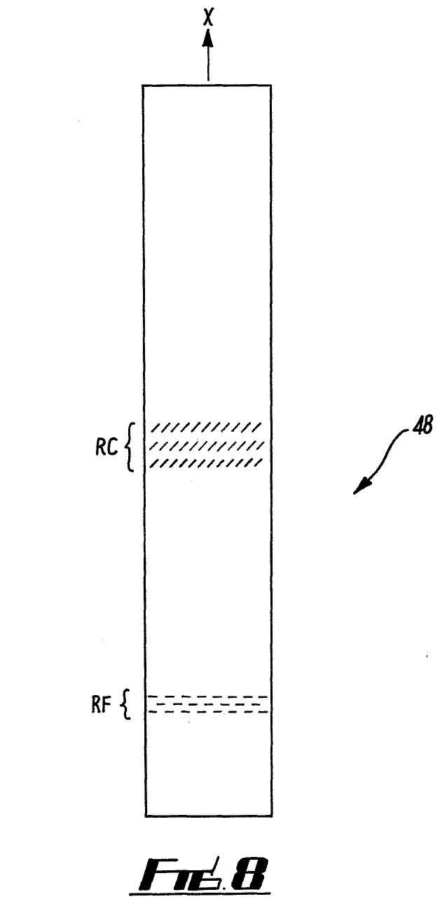

FIG. 8 is a moulding material according to a seventh embodiment of the present invention;

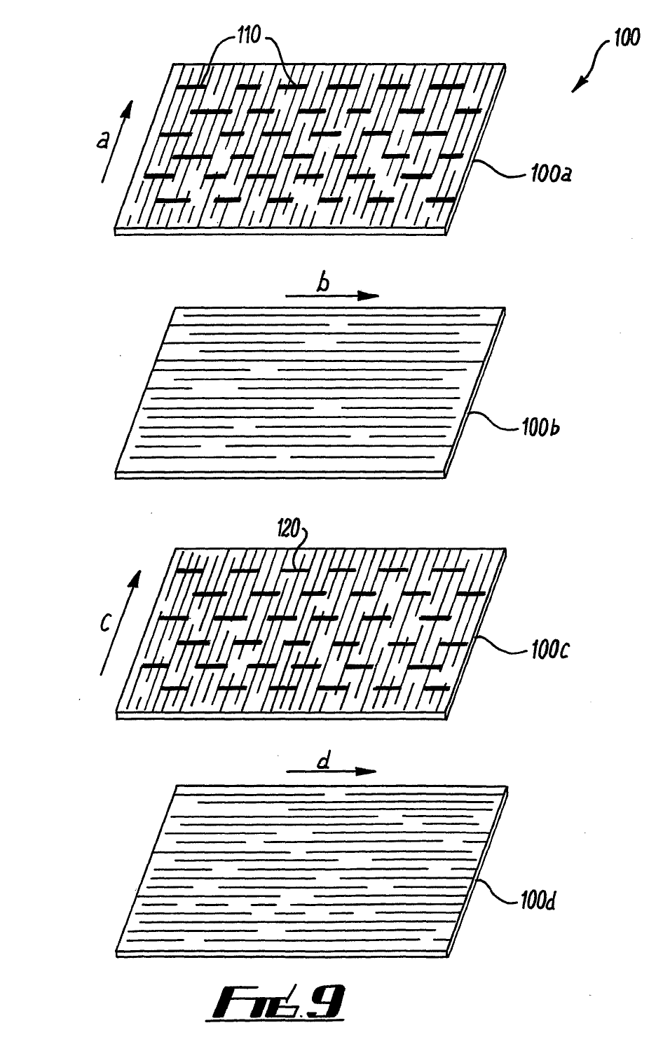

FIG. 9 is a moulding material according to an eighth embodiment of the present invention and;

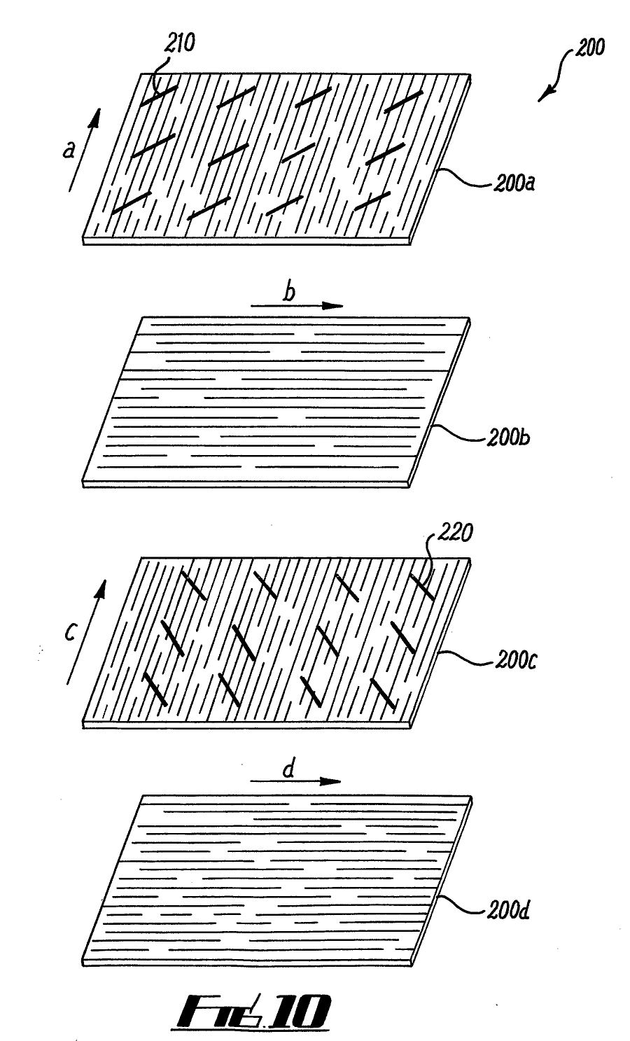

FIG. 10 is a moulding material according to a ninth embodiment of the present invention.

The invention provides moulding materials, methodology for manufacturing moulding materials, articles moulded from materials, kits and methodology for moulding articles using said materials, the moulding materials comprising a fibrous material comprising continuous reinforcement fibres at least some of which are cut at at least one point along their length. Continuous reinforcement fibres are generally unidirectional fibres, woven, knitted, braided or stitched fibrous materials.

FIG. 1 is a diagrammatic representation of a fibrous material in the form of a layer 10 comprising long lengths of unidirectional fibres 12 which extend along the length L of the layer in a generally parallel configuration. The view of FIG. 1 is a plan view. The thickness (not shown) of the fibrous layer 10 can be determined according to the intended use of the fibrous layer, and the fibrous layer 10 formed according to conventional techniques known to persons skilled in the art.

Layers of unidirectional fibre as generally shown in FIG. 1 are conventionally used as the fibre reinforcements in prepregs used in the production of fibre reinforced resinous composite materials. The close alignment of the fibres In such unidirectional structures provides for high volume fractions, generally in the range of 50-60% which provide for materials made using these fibre reinforcements to have relatively high mechanical properties. Also, unidirectional fibre reinforced composites exhibit superior surface finishes in comparison to composites comprising non-unidirectional fibre reinforcements. However, a significant disadvantage of such materials is that unidirectional prepregs do not conform well to complex geometries and therefore problems of bridging during the moulding process are common.

FIG. 2 is a diagrammatic representation of a moulding material 14 according to one embodiment of the present invention. The moulding material 14 comprises a fibrous layer 16 comprising continuous reinforcement fibres 18 each of which is cut at a plurality of points P1, P2, P3, P4, P5, P6, P7, P8 along its length L. Each cut extends through the thickness of the fibrous layer 16. The points P1 to P8 are generally equispaced such that each fibre 18 is cut into a series of relatively short substantially equal length sections S1, S2, S3, S4, S5, S6, S7, S8, S9. Each fibre 18 is effectively now discontinuous along its length, but the sections of each fibre generally remain in alignment along the length of the moulding material 14.

In this particular embodiment, since the cuts extend across the full width W of the fibrous layer 16, to maintain the integrity of the layer, in other words to prevent the sections S1 to S9 becoming displaced relative to one another, a support material (not shown) is provided. The support material can be in the form of a backing layer of any suitable material on which the fibrous layer 16 is releasably carried. The backing layer may, for instance, comprise a paper, plastics, resinous or other fibrous material.

The moulding material 14 exhibits advantages over known moulding materials, particularly during the production of moulded articles using the moulding material 14.

The alignment of the fibre lengths between the sections S1 to S9 provide the moulding material 14 generally with the advantages associated with the unidirectional fibrous material as shown in FIG. 1, i.e. relatively high mechanical strength of material produced therewith and high fibre volume fractions and superior surface finishes, whilst the relatively short length of the fibres in sections S1 to S9 enables the material to conform more accurately to intricate aspects and geometries of mould surfaces, such as corners, thus helping to mitigate disadvantages of bridging and poor drape characteristics often associated with unidirectional prepregs.

To maintain the alignment of the series of sections S1 to S9 within a fibre 18, requires that the cuts be provided using very sharp and accurate means to prevent displacement during cutting. The cuts may be formed by pressing a blade on to the fibres, or possibly rolling a blade over the fibres. These techniques are less likely to displace fibres than drawing a blade across the fibres.

However, some limited displacement of sections of fibres is not believed to significantly affect the performance and advantages of the moulding material 14 over conventional materials.

FIG. 3 is a diagrammatic representation of a moulding material 20 according to a second aspect of the present invention. As in the embodiment of FIG. 2, the moulding material comprises a fibrous layer 22 made up of an array of unidirectional fibres 22, cut at various positions along their length. In this embodiment, the cuts do not extend across the width W of the fibrous layer 22, but extend across only a part of that width and thus across only some of the fibres 24. Adjacent cuts in a direction across the width W of the fibrous layer 22 are staggered or displaced relative to one another in a direction along the length L of the fibrous layer 22. Providing the cuts in such a configuration helps to retain the integrity of the fibrous layer such that the need to provide a support material to support the fibre layer and help to retain the fibres in the configuration shown is obviated or mitigated, provided the material is handled carefully. However, a support material may be provided, generally in the form discussed above, if preferred.

Each cut is carefully made, in a lateral direction generally perpendicular to the direction in which the fibres 24 extend, a distance approximately one fifth of the width W. The cuts are all of substantially the same length and each extends across a portion of the width W, shown as W1, W2, W3, W4, W5. These are approximately one fifth of the width of the material. The fibres 24 extending across the width W1 are each cut at successive points P1 to P8. The fibres 24 in the width W2 are likewise cut at points P9 to P16, but each of these cuts is located at a position approximately midway between two of the adjacent positions P1 to P8 in the width W1 in the direction of the length L. For example, the cut P10 in W2 is located approximately midway between the positions P1 and P2 in the adjacent width portion W1.

Similarly in the other width portions W3, W4, W5, the cuts are staggered such that cuts in W1, W3, W5 are essentially at the same position (i.e. extend substantially coaxially across the width W) relative to the length L of the fibrous layer 22 and the cuts in the width regions W2, W4 are likewise in alignment.

The moulding material 20 of this embodiment benefits from the advantages generally associated with unidirectional prepregs, but also has improved drapeability and thus conforms more readily that convention unidirectional prepregs to intricate shapes such as corners within moulds and tools.

FIG. 4 shows a moulding material 26 according to a third embodiment of the present invention.

As in the previous embodiments, this moulding material 26 is derived from a layer of unidirectional continuous fibrous material generally as shown in FIG. 1, but comprises a pattern of cuts that extend generally diagonally at an angle in the order of 45° to the direction of the unidirectional fibres 30.

A series of cuts is provided across sequential sections L1 to L11 of the length L of the fibrous layer 28 and thus the fibres 30. In each of the sections L1 to L11 is a series of six cuts which extend generally parallel to each other. Indeed all of the cuts extend generally parallel to each other, but cuts between respective sections L1 to L11 are spaced apart, thus providing for lengths of fibre to extend between adjacent sections L1 to L11, to help maintain the integrity of the material and the relative portions of the cut fibres. Again with this configuration of cuts, each fibre 30 is cut at a plurality of positions along its length L to provide a series of generally aligned fibre sections. Each cut extends across only a portion of the width W of the fibrous layer 28, such that the fibrous layer 28 generally holds itself together. Provided the material is handled carefully it is not necessary to provide further support material to hold the fibrous layer 28 together to maintain its integrity. However, of course, a suitable support material, generally as discussed above, can be used if preferred.

Again, the mould material 26 of this embodiment enjoys the advantages usually associated with unidirectional prepregs, but does not suffer from the disadvantages of poor drape quality usually associated with such materials.

The embodiments described above show the present invention in relation to unidirectional fibre layers, but the invention is also applicable to other continuous fibre layers such as woven, stitched, braided or knitted fibres fabrics.

FIG. 5 illustrates an embodiment of the invention wherein the moulding material 32 comprises a fibre layer of continuous layer of woven fabric 34 having a configuration of cuts as generally described in relation to FIG. 4.

The provision of the cuts in accordance with the present invention provide the material 32 with improved drape characteristics over conventional woven fabrics, whilst otherwise enjoying the advantages generally associated with woven fabrics.

It will be appreciated that the configuration of cuts shown in relation to the embodiments of FIGS. 2 and 3 can also be readily employed on such woven fabrics and indeed other continuous fabric configurations such as braided, knitted and stitched fabrics.

The moulding materials discussed above find particular application in the production of fibre reinforced resinous composites and articles made therefrom. The moulding materials may therefore comprise a resinous material (not shown) that may be substantially wholly impregnated into the fibrous layer, may be partially impregnated, or otherwise attached to one or both sides of the fibrous layer.

The resinous material Will generally be selected according to the desired characteristics and application of the prepreg and the product moulded therefrom.

Thermoset resin such as one or more of epoxy, BMI, cyanate ester and phenolic resin can be used.

Additionally or as an alternative, thermoplastic resin, such as one or more of PES, PPIS, PI, PEI and PEEK may be used.

The fibrous material and the resinous material may be combined using conventional techniques.

Articles can be manufactured using the moulding material of the present invention, using conventional techniques. For fibre reinforced composite materials, the resin is generally uncured or partially cured in the moulding material, which can generally be termed a prepreg. Moulding materials can be layered into a mould or on a tool in generally conventional manner and subjected to conditions to consolidate the prepreg layers and cure the resinous material, usually under conditions of elevated temperature and/or pressure.

As discussed above, the moulding materials of the present invention exhibit improved drape characteristics over conventional continuous fibre prepregs, such that they are more easily formed into complex geometries and the known problem of “bridging” is reduced. The generally uniform distribution or arrangement of cuts in these embodiments over the material gives the material improved drape and conformability characterised generally uniformly over the entire area of the material.

It is within the scope of the present invention that the cuts may be provided at predetermined and selected regions of the fibrous material. These regions would generally be regions that have been predetermined as regions where the material will be required to have improved deformability and to conform to relatively intricate geometries during moulding, or otherwise have improved drape characteristics. In other regions where the material is not required to have improved deformability and thus where the relatively poor drape characteristics of the continuous fibrous material does not present any disadvantage when moulding the material, the fibres can remain uncut. This can improve the performance of the material and particularly articles moulded from the material. Indeed in other areas where some enhancement of the deformability is required, but to a lesser extent, the number, frequency and perhaps length of cuts can be reduced or otherwise amended to enable this required degree of deformation and conformity, without unnecessary weakening of the material and products made therefrom.

FIG. 7 is a diagrammatic representation of a moulding material 40 according to a sixth embodiment of the present invention. The moulding material 40 is shaped for use in moulding a bonnet or hood of an automobile. It comprises a continuous fibrous material (either unidirectional or other), the fibres of which extend generally in the direction of arrow X.

Three cut outs are provided 42, 44 and 46. The cut out 42 has been predetermined to facilitate the formation of an air intake during moulding of the material to form the bonnet, and the cut outs 44 and 46 are for the location of headlamps. Around these cut outs 42, 44, 46, and also around the periphery of the material 40 are regions that have been predetermined as regions where the poor inherent drape characteristics of the continuous fibrous material would unsatisfactorily hinder moulding of the material at these regions and so cuts C have been selectively made in these regions to improve the drape and deformability characteristics of the material 40 in these regions when in a mould or on a tool for moulding.

In a generally central region R, between the headlamp cut outs 44 and 46, a pattern of more broadly distributed cuts is provided. This region has been identified as requiring some improved drape characteristics (over uncut fibre) as some mould geometry conformity is required in this region, but the extent of the improvement in drape and thus conformity required is less than in the other regions and so the density of cuts required has been predetermined as less.

In the remainder of the material 40, the fibres have been left continuous (uncut), as here the inherent drape characteristics of the continuous fibrous material has been determined as not hindering the performance of the moulding material during moulding and therefore it is preferable to maintain the integrity of the fibres to maintain the inherent advantages thereof.

The cuts could be made manually, or they could be automated. For example, the cuts could be made using a CNC ply cutter, whilst or after the outer shape of the material 40 is being or has been cut.

As indicated in this embodiment, the cuts may get denser as the degree of drape and conformity gets greater and the detail or geometry to be adopted by that region gets more complex.

FIG. 8 shows a moulding material 48 according to a seventh embodiment of the present invention.

The moulding material 48 comprises a continuous fibrous material generally as discussed above, more in the form of an elongate tape with the fibres extending generally in the direction X along the length of the tape.

At a generally central region RC is provided a pattern of cuts that extend generally at an angle of approximately 45° to the direction X. These cuts are generally similar to those discussed in relation to FIGS. 4 and 5.

In a further region RF towards one end of the tape is a pattern of cuts generally similar to those in the embodiment of FIG. 3.

The precise pattern or configuration of the cuts can be varied according to parameters such as the desired drape characteristics within the respective regions RC, RF and/or the techniques or apparatus for providing the cuts.

Also the location and number of regions where cuts are provided along a tape or material can be varied and determined according to the intended application thereof. The regions RC and RF are simply illustrative of one in very many possible configurations.

The provision of the cuts at the central region RC provide that region RC with enhanced drape and conformability characteristics. Similarly, the cuts in the region RF provide that region with improved drape and conformability characteristics, relative to the rest of the material 48. The different cut patterns in the respective regions may give those regions different drape characteristics.

This enables the material 48 to be steered around more complex geometry about the regions RF and RC as the slashes would tend to open up and allow the outer edge of the tape to follow a larger radius than the inner edge.

It is within the scope of the present invention to provide moulding materials comprising a plurality of the moulding material layers discussed above. For example, a fibrous layer as described in any of the preceding embodiments may be located on top of another fibrous layer of the same or of an alternative embodiment. Where such multilayered materials, including prepregs or preforms are constructed, it is preferable that the cuts within the successive layers are not superimposed. Indeed, it is preferable that the cuts are orientated to be generally perpendicular in their direction relative to cuts in adjacent layers.

FIG. 9 shows a moulding material 100 comprising four separate layers 100a, 100b, 100c and 100d shown displaced in an “exploded” view for ease of illustration.

Each of the four layers comprises a layer of unidirectional fibrous material. The direction of the fibres in the fibrous layer 100a are generally in the direction of arrow a and similarly the direction of the fibres in layers 100b, 100c and 100d are generally in the direction of the respective arrows b, c and d.

The upper layer 100a has a pattern of cuts 110 of which each cut extends generally perpendicularly to the direction a of the fibres. The layer 100c has substantially the same configuration and pattern of cuts 120 therein. Some or all of the cuts 110, 120 may extend all the way through the respective layer 100a and 100c. The layers 100b and 100d have no cuts therein.

The layers 100a, b, c and d are layered one on top of the other.

The moulding material 100 can be laminated according to conventional techniques, including the application of pressure, adhesives, and/or other techniques to retain the layers 100a, b, c, d together prior to full cure. The material 100 may be part-cured as an intermediate step to full cure.

FIG. 10 shows a moulding material 100 comprising four layers 200a, b, c and d, which are again shown in an “exploded” configuration for ease of illustration.

Again the layers 200a, b, c, d each comprise unidirectional fibres extending generally in the direction of the respective arrows a, b, c and d.

The upper layer 200a comprises a pattern of cuts 210 which extend there across. Each cut 210 extends at approximately 45 degrees to the direction a of the unidirectional fibres.

Layer 200c has a similar pattern of cuts 220 which extend at 45 degrees to the general direction c of the unidirectional fibres therein, but are substantially perpendicular to the cuts 210 in the layer 200a.

The cuts 210, 220 may be placed to cut across each other in plan view at a point along their length, or the patterns may be displaced so the cuts do not cross, depending upon the design characteristics of the material 200. Some or all of the cuts 210 and/or 220 may extend all the way through the respective layer 200a, 200c.

The layers 200b and 200d have no cuts.

As in the previous embodiment, the layers 200a, b, c and d are laminated one above the other according to conventional techniques.

The above are two examples of the very many possible multi-layer configurations that can be achieved using the present invention. Any one or more of the layers may comprise dry fibres, resin impregnated fibres such as prepregs, or sided-prepregs. Any one of the layers may comprise a moulding material as hereinbefore described.

A tape placement machine may be used to build up laminates comprising a plurality of moulding material layers and particularly those in the form of a tape. The moulding material or tape is supplied on a roll or cassette usually in widths from 5 mm to 150 mm wide. An automated tape laying head is attached to a CNC gantry and the tape is automatically laid onto a mould or mandrel using rollers and automated cutters to consolidate and trim the material.

Most structures manufactured using conventional tape laying technologies are large, simple shaped aerospace structures, wing spars, wing skins, fairings and the like. The geometry is usually limited as continuous and particularly unidirectional tape cannot be steered around complex shapes as the tape will not stretch and so as material is steered around a radius, the inner fibres will bunch up and buckle. This problem increases as the material becomes wider and the radius sharper.

As a particular example of the present invention, the moulding material can be made up of two layers of moulding material 48 of relatively light weight (70 gms per square metre). One layer 48 is laminated on the other, with the cuts in the regions RC laid over each other, but at +45 and −45° so that they are not superimposed, although they may cross over at a point. The 140 gsm tape thus produced could then easily be steered around more complex shapes or radii at the regions RC and RF as the cuts would open up and allow the outer surface of the tape to follow a larger radius than the inner surface.

A tape laying machine could cut the respective layers prior to lamination.

With reference to FIG. 7, two or more layers of moulding material 40 may be laminated one above the other so the cut outs 42, 44 and 46 are superimposed. However the cuts C would be configured as to not be directly superimposed. In FIG. 7, if the cuts C are considered to be +45° relative to direction X, then in a layer laminated on top of that layer the cuts would extend perpendicularly at approximately −45° to the direction X.

FIG. 6 is a diagrammatic representation of a moulding material 36 comprising two layers of the moulding material 14a, b of the embodiment described in relation to FIG. 2. The first fibrous layer 16a of the lowermost layer 14a in orientated as generally shown in FIG. 2 with the fibres running along the length L and the cuts being provided at positions P1 to P12 extending across the width W of the material 36. The second uppermost layer 16b is located on top of the layer 16a such that the fibres therein run generally perpendicularly in their direction relative to the direction of the fibres in the lower layer 16a and the cuts across those fibres extend down the length L of the material at positions P13 to P17.

Particularly in relation to the embodiment described in relation to FIG. 2, providing two fibrous layers in this way helps stabilise the structure of the moulding material, whilst still providing the material with the improved drape and thus moulding characteristics sought.

Various modifications may be made without departing from the spirit or scope of the present invention.

In the above described embodiments, the cuts are generally described as generally being equispaced. It is within the scope of the present invention that irregular spacing of at least some or all of the cuts is provided and irregular or only partially regular patterns of cuts are provided. The cuts can be configured and sized according to the desired application and intended use of the particular moulding material. Some or possibly all of the cuts may be made to extend only partway through the thickness of the layer or material. The angle of the cuts can be between 20° and 110° relative to the direction of the fibres, and may be between 20° and 60°, the angle being determined according to the desired effect of the cuts on the characteristics of the material.

Unidirectional fibrous layers may have a fibre volume fraction in the order of 40-70%, and preferably 55 to 60%. When the fibrous layer is woven, stitched, knitted or braided, the fibre volume fraction may be approximately 30-65% or preferably 40-55%.

Of course any suitable number of materials of the present invention can be layered one above the other to provide a laminate with a desired plurality of layers. Intermediate layers or plys may be provided between layers of material of the present invention. The number, orientation, location, pattern and depth of the cuts in respective layers can be the same or different, enabling the material to be engineered to have predetermined characteristics, particularly drape characteristics.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-86. (canceled)

87. A moulding material comprising a fibrous material having continuous reinforcement fibres at least some of which are cut at least one point along their length, the cuts being selectively provided at one or more regions of the fibrous material, which regions have been predetermined as regions where the material will be required to conform to relatively complex or intricate shapes or profiles during moulding, the cuts facilitating conformation.

88. A moulding material as claimed in claim 87, in which each fibre comprises a plurality of sections at least some of which are generally aligned along the length of the fibre, each section comprising a relatively short length of fibre of between 5 and 100 mm in length.

89. A moulding material as claimed in claim 88, in which each relatively short length of fibre has a length within the range 15 to 75 mm.

90. A moulding material as claimed in claim 87, in which at least some of the fibres within the material are unidirectional, extending generally in one direction, and the cuts extend at an angle of between 20° and 110°, to the direction of the unidirectional fibres.

91. A method as claimed in claim 90, in which the angle is about 40°

92. A moulding material as claimed in claim 87, in which one or more of the cuts extend across between 5 and 50% of the said fibres.

93. A moulding material as claimed in claim 87, in which one or more of the cuts extend across between 15 to 30% of the said fibres.

94. A moulding material as claimed in claim 90, in which one or more cuts extend across all of the unidirectional fibres.

95. A moulding material as claimed in claim 87, which a repeating pattern of cuts is provided across the fibrous material.

96. A moulding material as claimed in claim 87, in which the fibrous material is in the form of a sheet or layer comprising a unidirectional material with a fibre volume fraction in the order of 40 to 70%.

97. A moulding material as claimed in claim 96, in which the fibrous layer comprises a woven, stitched, knitted or braided fabric with a fibre volume fraction of approximately 30% to 65%.

98. A moulding material as claimed in claim 87, in which the moulding material comprises support means to support the fibrous material and in particular cut fibres within the material to help retain them in said alignment and thus maintain the integrity of the material.

99. A moulding material as claimed in claim 98, in which the support means comprises a layer of support material on which the fibrous material is carried.

100. A moulding material as claimed in claim 98, in which the fibrous material is releasably attached to the support means.

101. A moulding material as claimed in claim 87, in which the moulding material comprises a resinous material provided on at least one surface of the fibrous material with no impregnation.

102. A moulding material as claimed in claim 87, in which the moulding material comprises a second fibrous material on one side of the said fibrous material.

103. A moulding material as claimed in claim 87, in which the moulding material comprises a plurality of layers of fibrous material at least one of said layers being orientated relative to the other, or at least one of the other layers, such that the direction of the fibres particularly for unidirectional fibres in the respective layers cross.

104. A moulding material as claimed in claim 103, in which the fibres cross generally mutually perpendicularly.

105. A moulding material as claimed in claim 103, in which the moulding material comprises two adjacent layers of said fibrous material, orientated such that the cut or at least some of the cuts, in one layer cross over each other and extend generally perpendicular to the or at least some of the cuts in the other layer.

106. A method of manufacturing a moulding material having a fibrous material comprising continuous reinforcement fibres, the method comprising cutting at least some of said continuous reinforcement fibres at least one point along their length, the cuts being selectively provided at one or more regions of the fibrous material, which regions have been predetermined as regions where the material will be required to conform to relatively complex or intricate shapes or profiles during moulding, the cuts facilitating conformation.

107. A method as claimed in claim 106, in which the fibres are cut to a length of between 5 and 100 min.

108. A method as claimed in claim 106, in which the fibres are cut to lengths of between 15 and 75 mm.

109. A method as claimed in claim 106, in which one or more of the cuts is made in a lateral direction across the lengths of the fibres at an angle of between 20° and 110° to the direction of the unidirectional fibres.

110. A method as claimed in claim 109, in which the angle is about 45°.

111. A method as claimed in claim 106, in which one or more of the cuts are made to extend across between 5 and 50% of the said fibres in the material.

112. A method as claimed in claim 106, in which one or more of the cuts are made to extend across between 15% and 30% of the fibres.

113. A method as claimed in claim 109, in which one or more of the cuts are made to extend across all of the unidirectional fibres.

114. A method as claimed in claim 106, in which the fibrous material is in the form of a fibrous layer or sheet of unidirectional material with a fibre volume fraction in the order of 45 to 70%.

115. A method as claimed in claim 114, in which the fibrous material used comprises woven, stitched, knitted or braided fabric with a fibre volume fraction of approximately 30% to 60%.

116. A method as claimed in claim 106, in which support means is used to support the fibrous material and in particular cut fibres within the material to help retain them in said alignment and thus maintain the integrity of the material.

117. A method as claimed in claim 116, in which the support means used comprises a layer of support material on which the fibrous material is carried.

118. A method as claimed in claim 106, in which a layer of resinous material is provided on at least one surface of the fibrous material with partial or no impregnation.

119. A method as claimed in claim 118, in which the resinous material used comprises the support means.

120. A method as claimed in claim 106, in which the moulding material is manufactured using a plurality of layers of fibrous material with at least one of said layers orientated relative to the or at least one of the other layers such that the direction of the fibres particularly for unidirectional fibres in the respective layers is generally mutually perpendicular.

121. A moulded article formed using a moulding material as defined in claim 87 or 105.

122. A method of moulding an article using a moulding material as defined in any of claim 87 or 105, the method comprising laying one or more layers of said moulding material in a mould or on a tool and subjecting said material to conditions to mould said material.
